(19) United States
(12) Patent Application Publication
(10) Pub. No.: US 2018/0130024 A1
(43) Pub. Date: May 10, 2018

(54) SYSTEMS AND METHODS TO IDENTIFY RESUMES BASED ON STAGED MACHINE LEARNING MODELS

(71) Applicant: Facebook, Inc., Menlo Park, CA (US)

(72) Inventors: Miaoqing Fang, Menlo Park, CA (US); Jesse William Czelusta, San Francisco, CA (US)

(21) Appl. No.: 15/346,162

(22) Filed: Nov. 8, 2016

(51) Int. Cl. G06Q 10/10; G06N 99/00

(52) U.S. Cl. CPC G06Q 10/1053; G06N 99/005

(57) ABSTRACT

Systems, methods, and non-transitory computer readable media are configured to generate a relevance score for each resume of a plurality of resumes associated with job candidates based on one or more machine learning models in a first stage associated with a job pipeline of an organization, the relevance score indicative of relevance of the resume in relation to the job pipeline. A subset of resumes are selected from the plurality of resumes, the subset of resumes having highest relevance scores. A quality score for each selected resume of the subset of resumes is generated based on a machine learning model in a second stage associated with the job pipeline, the quality score indicative of quality of the selected resume in relation to the job pipeline.

### FIELD OF THE INVENTION

The present technology relates to the field of machine learning. More particularly, the present technology relates to techniques for identifying resumes associated with job candidates (or positions) based on staged machine learning models.

### BACKGROUND

Recruiters can play a primary role in helping organizations locate job candidates. In some cases, a recruiter can proactively seek job candidates for the organization. In other cases, job candidates can initiate contact with an organization through a recruiter of the organization. The process to assess job candidates often can be initiated through electronic receipt by the organization of a resume of a job candidate. An organization can receive large volumes of resumes. The sheer number of resumes received by such an organization can create challenges for the recruiter in vetting the resumes to identify job candidates suited to the organization or a particular job position.

### SUMMARY

Various embodiments of the present technology can include systems, methods, and non-transitory computer readable media configured to generate a relevance score for each resume of a plurality of resumes associated with job candidates based on one or more machine learning models in a first stage associated with a job pipeline of an organization, the relevance score indicative of relevance of the resume in relation to the job pipeline. A subset of resumes are selected from the plurality of resumes, the subset of resumes having highest relevance scores. A quality score for each selected resume of the subset of resumes is generated based on a machine learning model in a second stage associated with the job pipeline, the quality score indicative of quality of the selected resume in relation to the job pipeline.

In an embodiment, the one or more machine learning models in the first stage associated with the job pipeline are a plurality of machine learning models, each machine learning model of the plurality of machine learning models generating a score relating to relevance of a resume in relation to the job pipeline.

In an embodiment, systems, methods, and non-transitory computer readable media generate for the resume a first score by a first machine learning model of the one or more machine learning models in the first stage associated with the job pipeline. A second score is generated for the resume by a second machine learning model of the one or more machine learning models in the first stage associated with the job pipeline. The first score and the second score are combined to generate the relevance score for the resume.

In an embodiment, the first score and the second score are weighted.

In an embodiment, the selecting a subset of resumes is based on a threshold amount of the plurality of resumes having highest relevance scores.

In an embodiment, systems, methods, and non-transitory computer readable media train the machine learning model in the second stage associated with the job pipeline based on features relating to structured data from a training set of data.

In an embodiment, the structured data relates to information relating to educational or professional achievements.

In an embodiment, systems, methods, and non-transitory computer readable media train the machine learning model in the second stage associated with the job pipeline based on features relating to relevance scores of resumes.

In an embodiment, systems, methods, and non-transitory computer readable media train the machine learning model in the second stage associated with the job pipeline based on labels relating to progress of a job candidate in recruitment related interactions with the organization.

In an embodiment, the labels include at least one of whether a resume is claimed by a recruiter, whether the recruiter performed outreach to a job candidate associated with the resume, whether the job candidate associated with the resume was provided a phone screening, and whether a job candidate associated with a resume was interviewed.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates a system including an example candidate selection module, according to an embodiment of the present technology.

FIG. 2 illustrates an example relevance determination module, according to an embodiment of the present technology.

FIG. 3 illustrates an example quality determination module, according to an embodiment of the present technology.

FIG. 4A illustrates an example method for generating a quality score, according to an embodiment of the present technology.

FIG. 4B illustrates an example method for generating a relevance score, according to an embodiment of the present technology.

FIG. 5 illustrate an example method for training a machine learning model in a second stage, according to an embodiment of the present technology.

FIG. 6 illustrates a network diagram of an example system that can be utilized in various scenarios, according to an embodiment of the present technology.

FIG. 7 illustrates an example of a computer system that can be utilized in various scenarios, according to an embodiment of the present technology.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### Searching for Resumes Based on Machine Learning Model

As mentioned, recruiters can play a primary role in helping organizations locate job candidates. In some cases, a recruiter can proactively seek job candidates for the organization. In other cases, job candidates can initiate contact with an organization through a recruiter of the organization. The process to assess job candidates often can be initiated through electronic receipt by the organization of a resume of a job candidate. Certain organizations can receive large volumes of resumes. The sheer number of resumes received by such organizations can create challenges for recruiters in vetting the resumes to identify suitable job candidates for a particular job position.

One common challenge confronted by organizations and their recruiters is effectively conducting computerized searching through vast amounts of resume data to match resumes of job candidates with certain job positions of the organization. One conventional technique attempts to address the challenge through use by recruiters of cumbersome keyword searches employing long strings of boolean logic. The computerized searches can reflect efforts by recruiters to comprehensively search through resumes for desired job candidates that satisfy various employment criteria applied by the recruiter. Another conventional technique can involve attempts to automate the assessment of a resume in relation to a job position. In this regard, one or more computer implemented algorithms can provide some quantitative measure regarding suitability of the resume in relation to the job position. However, the algorithms are often rudimentary and perform inaccurate assessments. In addition, different algorithms may provide results about a resume that reflect significant differences in their respective assessments.

An improved approach rooted in computer technology overcomes the foregoing and other disadvantages associated with conventional approaches specifically arising in the realm of computer technology. Systems, methods, and computer readable media of the present technology include a system of multi-staged machine learning models to identify highly qualified job candidates for various job classifications of an organization, such as job pipelines (or job area). In a first stage, one or more machine learning models can generate scores for resumes associated with job candidates based on their relevance to a job pipeline of the organization. For example, a machine learning model based on a synonymous search technique can be trained to score resumes in regard to a job pipeline. As another example, a machine learning model based on a tag space (or TagSpace) technique also can be trained to score resumes in regard to the job pipeline. Other machine learning models based on other resume scoring techniques are possible. For each job pipeline, the resume scores resulting from the machine learning models can be combined to generate an aggregate relevance score for each resume. For each job pipeline, the resumes can be sorted and ranked according to their relevance scores and a threshold amount of the resumes having the highest relevance scores for the job pipeline can be selected. In a second stage, a machine learning model for each job pipeline can generate a quality score for each selected resume for the job pipeline. A training set of data for the machine learning model can include labels relating to, for example, progress of a job candidate in her job related interactions with the company. The training set of data for the machine learning model can include features of structured data from resumes or other sources relating to, for example, information regarding significant educational or professional achievements. The features also can include relevance scores of resumes. A streamlined feature space including such features can optimize the machine learning model for identifying highly qualified job candidates for the job pipeline. More details regarding the present technology are described herein.

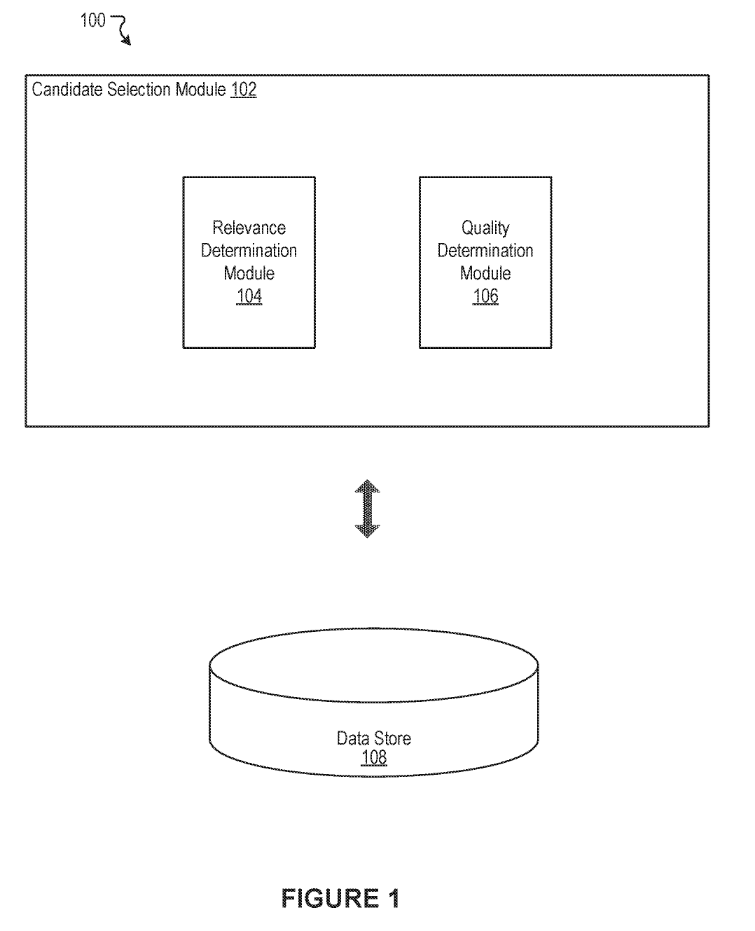

FIG. 1 illustrates an example system 100 including an example candidate selection module 102 configured to identify highly qualified job candidates for a job pipeline (or other job classification) for a recruiter for an organization, according to an embodiment of the present technology. The candidate selection module 102 includes a system of multi-stage machine learning models to identify the highly qualified job candidates. In some embodiments, one or more machine learning models in a first stage are used to generate relevance scores for a plurality of resumes (or resume related information, such as educational background, work experience, etc.) of job candidates regarding their general relevance to a job pipeline. A subset of resumes from the plurality of resumes associated with the highest relevance scores are selected. The subset of selected resumes is provided to a machine learning model in a second stage to generate quality scores to identify highly qualified job candidates for each job pipeline. The machine learning model of the second stage can be optimized by training on a streamlined feature space. Recruiters can be provided computerized search results or electronic notifications about highly qualified job candidates for job pipelines identified by the candidate selection module 102. For example, electronic notifications about highly qualified job candidates identified by the present technology can be provided to recruiters on demand or at regular intervals.

While some embodiments of the present technology are discussed herein in relation to a single job pipeline for clarity of description, the present technology applies to embodiments in which highly qualified job candidates are sought for a plurality of job pipelines of an organization. In these instances, for example, one or more machine learning models in a first stage can be dedicated to each job pipeline and a corresponding machine learning model in a second stage can be dedicated to the job pipeline. For instance, a first group of machine learning models in a first stage and a corresponding first machine learning model in a second stage can be dedicated to a first job pipeline; a second group of machine learning models in a first stage and a corresponding second machine learning model in a second stage can be dedicated to a second job pipeline; a third group of machine learning models in a first stage and a corresponding third machine learning model in a second stage can be dedicated to a third job pipeline; and so on. Accordingly, each job pipeline can be associated with one or more machine learning models for generation of relevance scores in a first stage and a corresponding machine learning model for generation of a quality score in a second stage.

Terms appearing herein are used flexibly. Job classifications, as used herein, can refer to terms that span a spectrum between coarse descriptors to fine grained descriptors associated with or otherwise indicative of a job position, responsibility, role, category, department, etc. Reference to a “job pipeline” (or “job area”, “role”, etc.) in connection with embodiments of the present technology can be understood as a relatively fine grained (or specific) descriptor of a job classification. In some embodiments, references to other job classifications can be used instead of a job pipeline. An organization can be any entity, such as a company, an establishment, a non-profit, a business, etc. The organization can be of any type or in any industry, such as aerospace and defense, agriculture, automotive, chemicals, construction, consumer goods and services, energy, financial services, firearms, food and beverage, health care, information and technology (e.g., software, hardware, etc.), real estate, manufacturing, mining and drilling, pharmaceuticals and biotechnology, publishing, telecommunications, transportation, etc. While a technology company or related job classifications may be exemplarily discussed in certain contexts for ease of explanation herein, an organization of any industry type or endeavor and related job classifications can be applicable to the present technology. For example, the present technology can be applied to any other type of organization by tailoring the training of machine learning models with features that are relevant to the type of organization and its recruiting strategy.

The candidate selection module 102 can include a relevance determination module 104 and a quality determination module 106. The components (e.g., modules, elements, steps, blocks, etc.) shown in this figure and all figures herein are exemplary only, and other implementations may include additional, fewer, integrated, or different components. Some components may not be shown so as not to obscure relevant details. In various embodiments, one or more of the functionalities described in connection with the candidate selection module 102 can be implemented in any suitable combinations.

The relevance determination module 104 can include one or more machine learning models in a first stage of the present technology to generate scores that reflect a general relevance of resumes associated with job candidates to a particular job pipeline (e.g., Android software engineer, 105 software engineer, systems software engineer, production software engineer, etc.). Each machine learning model of the one or more machine learning models can generate a score regarding a degree to which a resume of a plurality of resumes is relevant to a particular job pipeline. The scores for the resume can be combined to generate an aggregated relevance score. For each job pipeline, the resumes can be sorted and ranked based on their relevance scores, and a threshold amount of the highest ranking resumes can be selected. The relevance determination module 104 is discussed in more detail herein.

The quality determination module 106 can include, for each job pipeline, a machine learning model (or more than one machine learning model) in a second stage to determine highly qualified job candidates from the resumes selected by the relevance determination module 104. The machine learning model can be trained to generate a quality score for each resume in relation to the job pipeline. Resumes can be sorted and ranked based on their quality score. A threshold amount of resumes having highest quality scores can be provided to a recruiter of an organization as highly qualified candidates for the job pipeline. The quality determination module 106 is discussed in more detail herein.

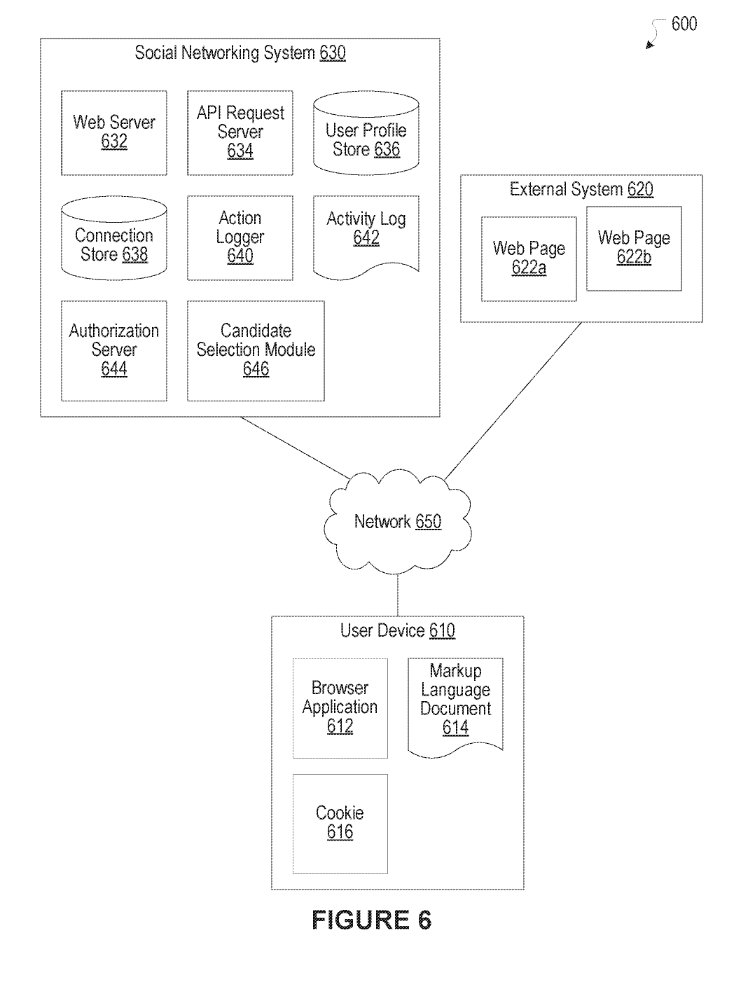

In some embodiments, the candidate selection module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the candidate selection module 102 can be, in part or in whole, implemented as software running on one or more computing devices or systems, such as on a server or a client computing device. For example, the candidate selection module 102 can be, in part or in whole, implemented within or configured to operate in conjunction or be integrated with a social networking system (or service), such as a social networking system 630 of FIG. 6. As another example, the candidate selection module 102 can be implemented as or within a dedicated application (e.g., app), a program, or an applet running on a user computing device or client computing system. In some instances, the candidate selection module 102 can be, in part or in whole, implemented within or configured to operate in conjunction or be integrated with client computing device, such as a user device 610 of FIG. 6. It should be understood that many variations are possible.

The system 100 can include a data store 108 configured to store and maintain various types of data, such as the data relating to support of and operation of the candidate selection module 102. The data store 108 also can maintain other information associated with a social networking system. The information associated with the social networking system can include data about users, social connections, social interactions, locations, geo-fenced areas, maps, places, events, groups, posts, communications, content, account settings, privacy settings, and a social graph. The social graph can reflect all entities of the social networking system and their interactions. As shown in the example system 100, the candidate selection module 102 can be configured to communicate and/or operate with the data store 108.

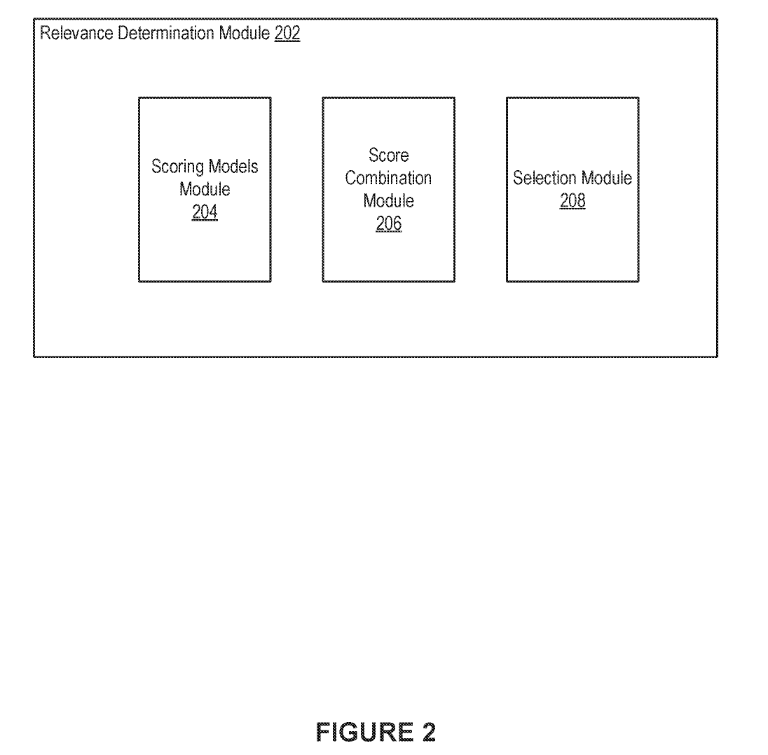

FIG. 2 illustrates an example relevance determination module 202, according to an embodiment of the present technology. In some embodiments, the relevance determination module 104 of FIG. 1 can be implemented with the relevance determination module 202. The relevance determination module 202 can include a scoring models module 204, a score combination module 206, and a selection module 208.

The scoring models module 204 can include one or more machine learning models in a first stage to generate scores indicative of a degree to which a plurality of resumes are relevant to job pipelines of an organization. In some embodiments, each job pipeline can be associated with one or more machine learning models. In some embodiments, the machine learning models can be trained with a training set of data including a resume corpus of any suitable number (e.g., 2 million, 500, etc.) of resumes (or curricula vitae) as a bag of words. In various embodiments, the machine learning models also can be trained on information relating to educational history and professional experience of job candidates from other data sources apart from resumes, such as online data sources and professional networking websites that maintain such information. In some embodiments, profile information and interactions (e.g., likes, comments, shares, group membership, etc.) of job candidates on a social networking system may also be used for training. In some instances, structured data from the resumes (or other data sources) can be selected as features for training. The structured data can include information relating to, for example, skills, past projects, and experience reflected in the resumes.

One example of a machine learning model supported by the scoring models module 204 relates to a synonymous search technique. Resumes can be identified and scored based on their relevance to one or more search terms associated with searches performed by a recruiter. A machine learning model for a job pipeline can be trained using terms from the resume corpus. The model can be based on a technique (e.g., word2vec) that converts the terms into vector representations in a vector space based on meaning of the terms. A set of search terms used by a plurality of recruiters for a job pipeline can be represented in the vector space as a set of keywords (or anchor points). In some embodiments, when a recruiter wishes to perform one or more searches on a set of resumes, each resume can be converted into an array of values representing a frequency of unique keywords by determining, for each identified chunk of terms in the resume, a nearest keyword. Each array of values representing a frequency of unique keywords can be normalized to reflect the relative importance of the keywords associated with array. An array of values representing a frequency of search terms associated with a search for the job pipeline can be generated. The array of values associated with a resume and the array of values associated with search terms for the job pipeline can be combined (e.g., as a dot product) to generate a score for each resume regarding relevance to the job pipeline. Many variations are possible.

Another example of a machine learning model supported by the scoring models module 204 relates to a tag space (or TagSpace) technique. Resume tokens from the resume corpus can constitute a training set of data to train a machine learning model. In addition, tags associated with resumes can be included in the training set of data. In some instances, the tags can be manually selected terms relevant to the resume but not expressly included in the resume text itself. For example, a tag for a resume can be a job pipeline determined for the resume or a job title. The machine learning model can be based on a technique that converts the resume tokens and the tags into vector representations in a vector space based on meaning of the tokens and the tags. The machine learning model can be used to recommend job classifications, such as job pipelines, for resumes. The machine learning model can be used in an evaluation stage to determine a score that is indicative of a degree to which a resume is relevant to a job pipeline. In this regard, a resume can be represented as an average vector of the vectors representing the tokens and the tags associated with the resume. A particular job pipeline can be represented as an average vector of the vectors representing terms associated with the job pipeline. A distance between the average vector associated with the resume and the average vector associated with the job pipeline can represent a score regarding the relevance of the resume in relation to the job pipeline. Many variations are possible.

Additional machine learning models to generate scores for a plurality of resumes that indicate a degree to which the resumes are relevant to a job pipeline can be used in other embodiments. One or more other machine learning models other than the machine learning model relating to the synonymous search technique and the machine learning model relating to the tag space technique can be used by the candidate selection module 102. In some embodiments, the candidate selection module 102 is agnostic as to the types of scoring algorithms employed.

The score combination module 206 can generate an aggregate relevance score for a plurality of resumes based on scores determined by one or more machine learning models in a first stage associated with a job pipeline. For example, the score combination module 206 can aggregate (e.g., sum, average, etc.) two scores generated by two different machine learning models associated with a job pipeline to generate a relevance score for each resume of the plurality of resumes. As another example, the score combination module 206 can combine three or more scores generated by three or more different machine learning models associated with a job pipeline to generate a relevance score for each resume of the plurality of resumes. In some embodiments, the score combination module 206 can determine a weight for each score generated by a machine learning model and apply (e.g., multiply) the weight to each score before aggregating a plurality of scores to generate a relevance score for a resume. In some embodiments, the weight can be determined based at least in part on claimable resume percentages associated with the corresponding machine learning model as determined in a manual review phase by recruiters. For example, with respect to a particular job pipeline (e.g., Android SWE), a weight can be a claimable resume percentage associated with an associated machine learning model (e.g., 35%). In some embodiments, training an ensemble model (such as logistic regression) is another way to calculate weights.

The selection module 208, for each job pipeline, can sort and rank the plurality of resumes based on their relevance scores. The selection module 208 can select a subset of resumes from the plurality of resumes. The subset of selected resumes can represent a threshold amount of the plurality of resumes having the highest relevance scores for a job pipeline. The threshold amount can be determined based on a total number of resumes associated with potential job candidates, organizational demand for job candidates for a job pipeline, and other factors. In some embodiments, the threshold amount can be a selected percentage of resumes having the highest relevance scores (e.g., top 1%). In other embodiments, the threshold amount can be a selected number of resumes having the highest relevance scores (e.g., 10, 25, etc.). The subset of selected resumes can be provided for a second stage of the present technology.

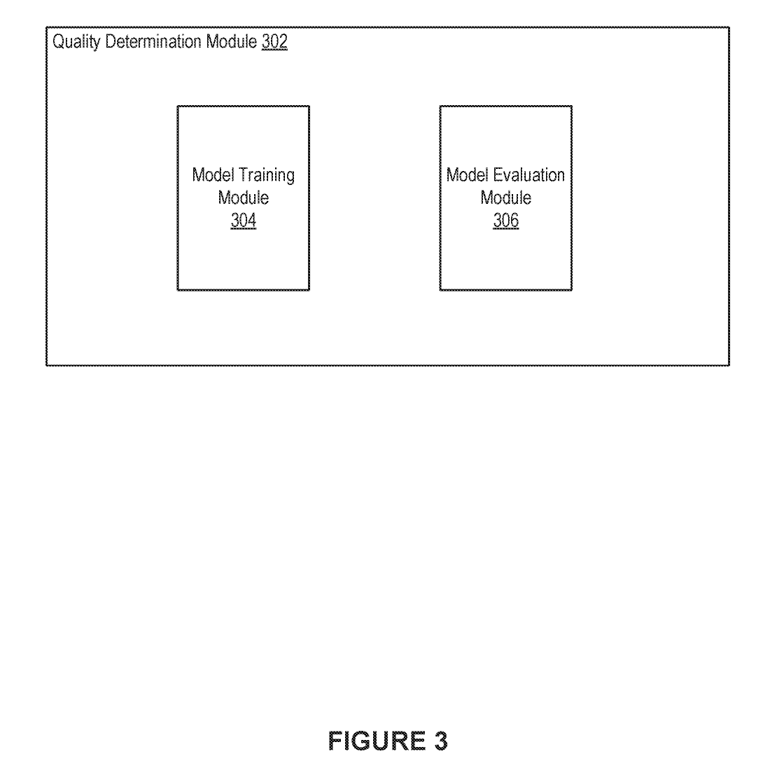

FIG. 3 illustrates an example quality determination module 302, according to an embodiment of the present technology. In some embodiments, the quality determination module 106 of FIG. 1 can be implemented with the quality determination module 302. The quality determination module 302 can include a model training module 304 and a model evaluation module 306.

The model training module 304 can include a plurality of machine learning models in a second stage to generate quality scores to identify resumes associated with highly qualified job candidates for job pipelines of an organization. In some embodiments, each job pipeline is associated with a machine learning model (or many machine learning models) trained with a training set of data. In some embodiments, the training set of data can include selected features and labels. In various embodiments, the selected features can include structured data reflected in resumes and other data sources apart from resumes, such as online data sources and professional networking websites that maintain such information. For example, the structured data can include information relating to significant educational or professional achievements. In one instance, the structured data can include schools (or top schools), employers (or top employers), degrees (e.g., Ph.D.'s), publications, patents, etc. In some embodiments, a relevance score for a resume also can be a selected feature on which the machine learning model is trained. Other features can be selected in other embodiments by feature engineering techniques. Use of structured data as selected features in a streamlined feature space can optimize the machine learning model, especially when a number of positive samples to train the machine learning model is relatively small.

The model training module 304 also can train the machine learning model based on one or more labels. In some embodiments, the machine learning model can be a binary classifier trained on a label. In other embodiments, the machine learning model be a multi-class classifier trained on a plurality of labels. In one instance, a label can relate to progress of a job candidate in recruitment related interactions with an organization. For example, a label can include whether a resume is claimed by a recruiter, whether a recruiter performed outreach to a job candidate associated with a resume, whether a job candidate associated with a resume was provided a phone screening, whether a job candidate associated with a resume was interviewed, etc. In some embodiments, one label (e.g., whether a recruiter performed outreach to a job candidate associated with a resume) can be used to train the machine learning model. In other embodiments, another label or many other labels can be used to train the machine learning model.

The model evaluation module 306 can apply the subset of selected resumes determined by the relevance determination module 202 to the machine learning model. The machine learning model can generate a quality score for each resume of the subset of selected resumes. Quality scores for the resumes can be used to identify resumes associated with highly qualified job candidates for an associated job pipeline. In this regard, the subset of selected resumes can be sorted and ranked based on their quality scores. The model evaluation module 306 can determine a threshold amount of the subset of selected resumes having the highest quality scores. The threshold amount can be a selected number of resumes having the highest quality scores (e.g., 5, 10, etc.) or a selected percentage of resumes having the highest relevance scores (e.g., top 10%). The threshold amount of resumes from the subset of selected resumes that are determined to have the highest quality scores for a job pipeline can represent highly qualified job candidates. The highly qualified job candidates can be identified for a recruiter to consider in a recruitment process for an organization.

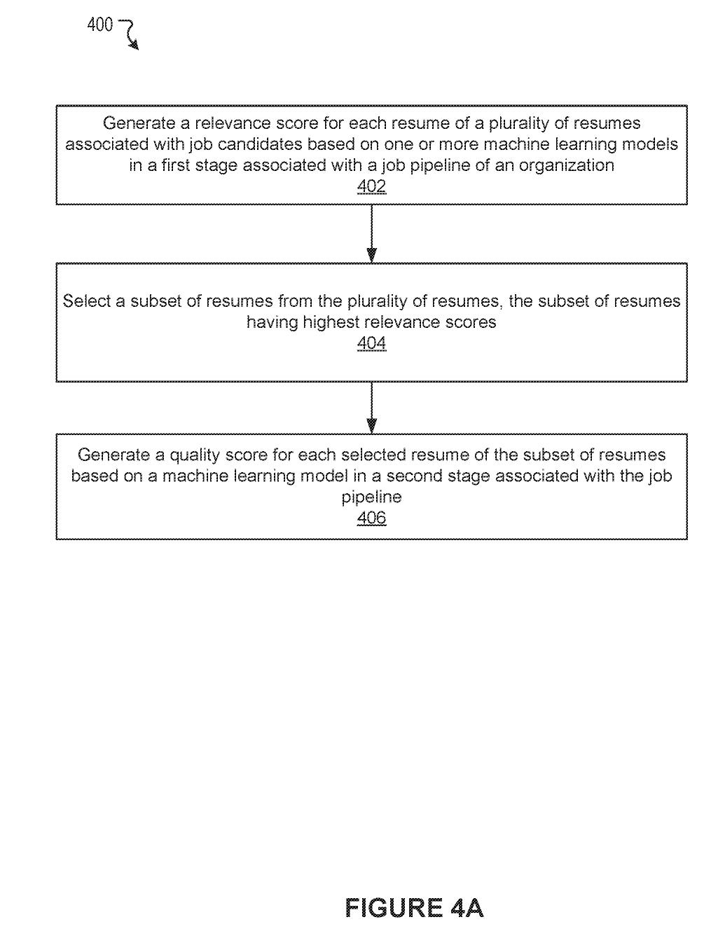

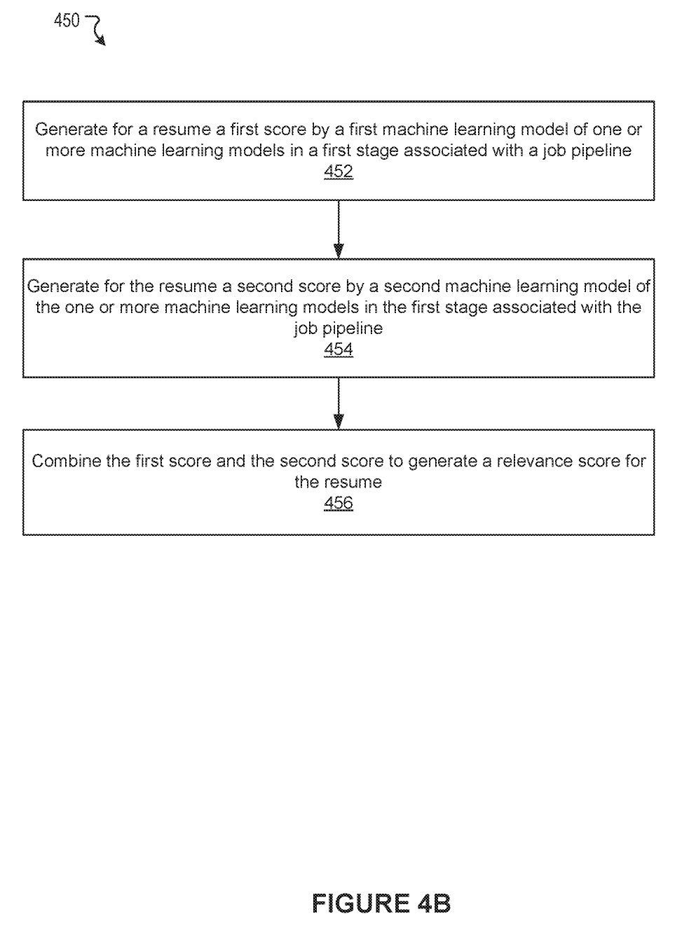

FIG. 4A illustrates an example method 400 to generate a quality score for a resume in relation to a job pipeline, according to an embodiment of the present technology. It should be appreciated that there can be additional, fewer, or alternative steps performed in similar or alternative orders, or in parallel, in accordance with the various embodiments and features discussed herein unless otherwise stated.

At block 402, the method 400 can generate a relevance score for each resume of a plurality of resumes associated with job candidates based on one or more machine learning models in a first stage associated with a job pipeline of an organization. At block 404, the method 400 can select a subset of resumes from the plurality of resumes, the subset of resumes having highest relevance scores. At block 406, the method 400 can generate a quality score for each selected resume of the subset of resumes based on a machine learning model in a second stage associated with the job pipeline. Other suitable techniques that incorporate various features and embodiments of the present technology are possible.

FIG. 4B illustrates an example method 450 to generate a relevance score that reflects a degree to which a resume is relevant to a job pipeline, according to an embodiment of the present technology. It should be appreciated that there can be additional, fewer, or alternative steps performed in similar or alternative orders, or in parallel, in accordance with the various embodiments and features discussed herein unless otherwise stated.

At block 452, the method 450 can generate for a resume a first score by a first machine learning model of one or more machine learning models in a first stage associated with a job pipeline. At block 454, the method 450 can generate for the resume a second score by a second machine learning model of the one or more machine learning models in the first stage associated with the job pipeline. At block 456, the method 450 can combine the first score and the second score to generate a relevance score for the resume. Other suitable techniques that incorporate various features and embodiments of the present technology are possible.

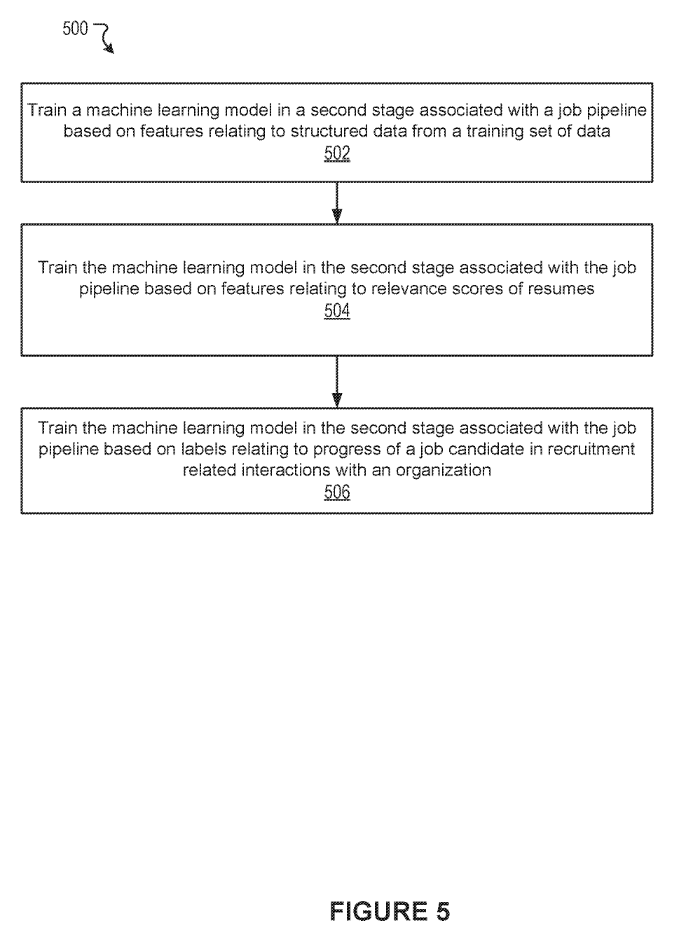

FIG. 5 illustrates a first example method 500 to train a machine learning model in a second stage, according to an embodiment of the present technology. It should be appreciated that there can be additional, fewer, or alternative steps performed in similar or alternative orders, or in parallel, in accordance with the various embodiments and features discussed herein unless otherwise stated.

At block 502, the method 500 can train a machine learning model in a second stage associated with a job pipeline based on features relating to structured data from a training set of data. At block 504, the method 500 can train the machine learning model in the second stage associated with the job pipeline based on features relating to relevance scores of resumes. At block 506, the method 500 can train the machine learning model in the second stage associated with the job pipeline based on labels relating to progress of a job candidate in recruitment related interactions with an organization. Other suitable techniques that incorporate various features and embodiments of the present technology are possible.

It is contemplated that there can be many other uses, applications, features, possibilities, and variations associated with various embodiments of the present technology. For example, users can choose whether or not to opt-in to utilize the present technology. The present technology also can ensure that various privacy settings, preferences, and configurations are maintained and can prevent private information from being divulged. In another example, various embodiments of the present technology can learn, improve, and be refined over time.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 655. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 655. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 655. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 655, which may comprise any combination of local area and/or wide area networks, using wired and/or wireless communication systems.

In one embodiment, the network 655 uses standard communications technologies and protocols. Thus, the network 655 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 655 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 655 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 655. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 655.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 655. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 655, and the API request server 634 receives the API request. The API request server 634 processes the request by calling an API associated with the API request to generate an appropriate response, which the API request server 634 communicates to the external system 620 via the network 655. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a candidate selection module 646. The candidate selection module 646 can be implemented with the candidate selection module 102, as discussed in more detail herein. In some embodiments, one or more functionalities of the candidate selection module 646 can be implemented in the user device 610.

### Hardware Implementation

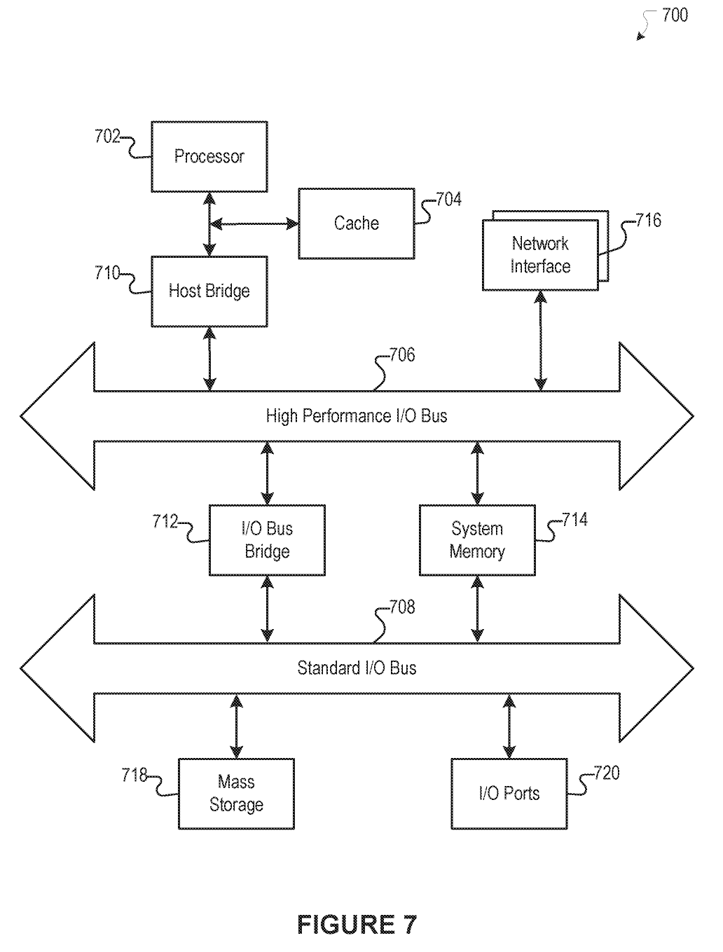

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
generating, by a computing system, a relevance score for each resume of a plurality of resumes associated with job candidates based on one or more machine learning models in a first stage associated with a job pipeline of an organization, the relevance score indicative of relevance of the resume in relation to the job pipeline;
selecting, by the computing system, a subset of resumes from the plurality of resumes, the subset of resumes having highest relevance scores; and
generating, by the computing system, a quality score for each selected resume of the subset of resumes based on a machine learning model in a second stage associated with the job pipeline, the quality score indicative of quality of the selected resume in relation to the job pipeline.

2. The computer-implemented method of claim 1, wherein the one or more machine learning models in the first stage associated with the job pipeline are a plurality of machine learning models, each machine learning model of the plurality of machine learning models generating a score relating to relevance of a resume in relation to the job pipeline.

3. The computer-implemented method of claim 1, further comprising:
generating for the resume a first score by a first machine learning model of the one or more machine learning models in the first stage associated with the job pipeline;
generating for the resume a second score by a second machine learning model of the one or more machine learning models in the first stage associated with the job pipeline; and
combining the first score and the second score to generate the relevance score for the resume.

4. The computer-implemented method of claim 3, wherein the first score and the second score are weighted.

5. The computer-implemented method of claim 1, wherein the selecting a subset of resumes is based on a threshold amount of the plurality of resumes having highest relevance scores.

6. The computer-implemented method of claim 1, further comprising training the machine learning model in the second stage associated with the job pipeline based on features relating to structured data from a training set of data.

7. The computer-implemented method of claim 6, wherein the structured data relates to information relating to educational or professional achievements.

8. The computer-implemented method of claim 1, further comprising training the machine learning model in the second stage associated with the job pipeline based on features relating to relevance scores of resumes.

9. The computer-implemented method of claim 1, further comprising training the machine learning model in the second stage associated with the job pipeline based on labels relating to progress of a job candidate in recruitment related interactions with the organization.

10. The computer-implemented method of claim 9, wherein the labels include at least one of whether a resume is claimed by a recruiter, whether the recruiter performed outreach to a job candidate associated with the resume, whether the job candidate associated with the resume was provided a phone screening, and whether a job candidate associated with a resume was interviewed.

11. A system comprising:
at least one processor; and
a memory storing instructions that, when executed by the at least one processor, cause the system to perform:
generating a relevance score for each resume of a plurality of resumes associated with job candidates based on one or more machine learning models in a first stage associated with a job pipeline of an organization, the relevance score indicative of relevance of the resume in relation to the job pipeline;
selecting a subset of resumes from the plurality of resumes, the subset of resumes having highest relevance scores; and
generating a quality score for each selected resume of the subset of resumes based on a machine learning model in a second stage associated with the job pipeline, the quality score indicative of quality of the selected resume in relation to the job pipeline.

12. The system of claim 11, wherein the one or more machine learning models in the first stage associated with the job pipeline are a plurality of machine learning models, each machine learning model of the plurality of machine learning models generating a score relating to relevance of a resume in relation to the job pipeline.

13. The system of claim 11, further comprising:
generating for the resume a first score by a first machine learning model of the one or more machine learning models in the first stage associated with the job pipeline;
generating for the resume a second score by a second machine learning model of the one or more machine learning models in the first stage associated with the job pipeline; and
combining the first score and the second score to generate the relevance score for the resume.

14. The system of claim 11, wherein the selecting a subset of resumes is based on a threshold amount of the plurality of resumes having highest relevance scores.

15. The system of claim 11, further comprising training the machine learning model in the second stage associated with the job pipeline based on features relating to structured data from a training set of data.

16. A non-transitory computer-readable storage medium including instructions that, when executed by at least one processor of a computing system, cause the computing system to perform a method comprising:
generating a relevance score for each resume of a plurality of resumes associated with job candidates based on one or more machine learning models in a first stage associated with a job pipeline of an organization, the relevance score indicative of relevance of the resume in relation to the job pipeline;
selecting a subset of resumes from the plurality of resumes, the subset of resumes having highest relevance scores; and
generating a quality score for each selected resume of the subset of resumes based on a machine learning model in a second stage associated with the job pipeline, the quality score indicative of quality of the selected resume in relation to the job pipeline.

17. The non-transitory computer-readable storage medium of claim 16, wherein the one or more machine learning models in the first stage associated with the job pipeline are a plurality of machine learning models, each machine learning model of the plurality of machine learning models generating a score relating to relevance of a resume in relation to the job pipeline.

18. The non-transitory computer-readable storage medium of claim 16, further comprising:
generating for the resume a first score by a first machine learning model of the one or more machine learning models in the first stage associated with the job pipeline;
generating for the resume a second score by a second machine learning model of the one or more machine learning models in the first stage associated with the job pipeline; and
combining the first score and the second score to generate the relevance score for the resume.

19. The non-transitory computer-readable storage medium of claim 16, wherein the selecting a subset of resumes is based on a threshold amount of the plurality of resumes having highest relevance scores.

20. The non-transitory computer-readable storage medium of claim 17, further comprising training the machine learning model in the second stage associated with the job pipeline based on features relating to structured data from a training set of data.
